(19) United States
(12) Patent Application Publication
(10) Pub. No.: US 2004/0007453 A1
(43) Pub. Date: Jan. 15, 2004

(54) Photocatalytic air purifier

(76) Inventors: John Scahill, Evergreen, CO (US); Mark Anselmo, Arvada, CO (US); Daniel M Blake, Golden, CO (US); Edward J Wolfrum, Lakewood, CO (US)

Correspondence Address: Paul J White, Senior Counsel, National Renewable Energy Laboratory, 1617 Cole Boulevard, Golden, CO, 80401, US

(21) Appl. No.: 10/333,561

(22) PCT Filed: Apr. 13, 2001
(86) PCT No.: PCT/US01/12214

(51) Int. Cl. B01J 19/08

(52) U.S. Cl. 204/157.3; 422/186.3

(57) ABSTRACT

A photocatalytic air purifier (10) is provided which includes a tubular housing (1) having an inner and an outer wall, a central axis (A), a first end (2) having a centrally located air intake nozzle (4), a second end (5) having at least one air exhaust port (6), an air exhaust plenum (11) between the inner housing wall and a radial porosity medium (12), the porosity medium (12) extending radially and axially about the axis, and a housing central portion (13) defined by an interior perimeter of the radial porosity medium (12), the central housing enclosing an ultraviolet lamp (20) and a packing medium (30), the packing medium (30) extending radially and axially about the lamp (20) and comprising a plurality of spiral wound filaments (32) coated with a photocatalytic film.

### CONTRACTUAL ORIGIN OF THE INVENTION:

The United States Government has rights to this invention pursuant to Contract No. DE-AC36-99GO-10337 between the United States Department of Energy and the Midwest Research Institute.

### TECHNICAL FIELD

The present invention relates to an air purifier and, in particular, to an efficient and compact photocatalytic air purifier which is simple in design for the removal of volatile organic compounds and bio-aerosols from a contaminated air stream.

### BACKGROUND ART

Metal oxides have a function of decomposing organic compounds which are in contact therewith or present close thereto by oxidization when excited by ultraviolet rays, and thus are called photocatalytic semiconductors. Among photocatalytic semiconductors, titanium dioxide (TiO₂) exhibits an extremely high oxidizing catalytic action and is superb in terms of stability and safety. Many applications of titanium dioxide are known. Among known applications, titanium dioxide may be processed to a fine powder, and the fine powder may be applied as a film on a surface of a substrate to constitute a photo-catalyst. Another method of application is a sol-gel process whereby TiO₂ is dissolved in a liquid solution, that coats the substrate, and is subsequently calcimined at elevated temperatures to provide a crystal structure at the surface. When the photo-catalyst is irradiated by ultraviolet light, it exhibits a high oxidizing capability which can be utilized to decompose organic compounds. The oxidation efficiency is thus dependent on an even distribution of the illumination on the catalyst, the surface area of the catalyst to be illuminated, and an even distribution of the reactant to be oxidized.

It is well known that photocatalytic semiconductors are useful for deodorizing, cleaning, sterilizing and purifying air in the interiors of rooms and cabins of automobiles, trains, ships and the likes. Accordingly, attention has been drawn to photocatalytic systems for the purification of an air stream in these environments. One example of a device using photocatalytic action of a semiconductor for removing malodorous substances by decomposition consists of a deodorizing lamp. Toada et al., U.S. Pat. No. 5,650,126, discloses a deodorizing lamp having a lamp unit and a titanium oxide film coating on the glass surface of the lamp unit and optionally at least one metal selected from among iron, platinum, rhodium, ruthenium, palladium, silver, copper, zinc, and manganese deposited on the surface of the titanium oxide film. However, while the deodorizing lamp provides an even distribution of the illumination on the catalyst, the surface area of the catalyst is limited to the surface area of the light bulb.

One way to increase the surface area of the photocatalyst in an air purifier system is to deposit the photocatalysts on molded substrates. For example, U.S. Pat. No. 6,074,748, issued to Ogata, discloses molded articles having a photocatalytic function of a desired shape, such as interlocking blocks, to provide a large contact area being sufficiently irradiated with ultraviolet rays. Unit particles, such as a gathering and entangling unit glass filaments, are bonded to one another into the desired shape. Subsequently, a photocatalytic functional layer is formed on a surface of each particle or fiber. Japan Patent, 11112028, 1999, discloses an air purification apparatus having a cylindrical shape containing a UV lamp in the inside and includes a cylindrical photocatalyst member made of a sheet bearing a phototcatalyst and installed between the UV lamp and the circumferential wall of the cylinder. Fujishima et al., U.S. Pat. No. 5,948,355, describes an air-purifying filter for an automobile which includes a carrier base and a TiO₂-Pd composite catalyst supported on the carrier base. The air purifier has a light source for irradiating the filter, and an exhaust port, arranged at a position to utilize negative pressure of the automobile generated during driving, to exhaust any substances desorbed from the composite catalyst to the outside of the automobile. Yamanake et al., U.S. Pat. No. 5,9919,422, describes a compact titanium dioxide photo-catalyzer disposed on a substrate and a light-emitting diode disposed adjacent to the titanium dioxide film and producing an ultraviolet light having a wavelength from 360 to 400 nm on to the titanium dioxide film. However, a distinct disadvantage in the use of organic fibers, binders, and adhesives for molded substrates is that they are known to break down when in contact with a photocatalyst as a result of the photocatalytic process itself, therefore rendering them ineffective due, in part, to compacting to the packing medium, after a short period of time. Moreover, the use of screens, filters, and films as a catalyst support often contributes to a high pressure drop, in the air flow, which interferes with an even distribution of the air to be oxidized, and requires more motive force to move the air.

Therefore what is needed is a photocatalytic air purification system which is inexpensive in manufacture and operation, but which is characterized by an even distribution of the illumination on a high-surface-area catalyst and of a low resistance to the air stream to be oxidized. It is desirable that the catalyst be of a self supporting design so as to eliminate a need for the inclusion of organic fibers, binders and adhesives, which would contribute to a longer life time, and resulting reduction in cost.

### DISCLOSURE OF INVENTION

It is therefore an object of the invention to provide an efficient photocatalytic air purifier for the removal of volatile organic compounds and bio-aerosols from a contaminated air stream.

It is another object of the invention to provide a binder free packing medium, of a self supporting geometry, having a large photocatalytic surface area and characterized by a low pressure drop when loaded into a photocatalytic air purifier.

It is a further object of the invention to provide a photocatalytic air purifier which provides a relatively uniform distribution of contaminated air throughout the packing medium.

It is still a further object of the invention to provide an even distribution of the illumination on the catalyst by reflection and partial transmission of light through the packing medium.

It is yet another object of the invention to provide a compact photocatalytic air purifier characterized by ease in assembly, but which is useful with a replaceable catalytic support.

Additional advantages of the present invention will be set forth in part in the description that follows and in part will be obvious for that description or can be learned from practice of the invention. The advantages of the invention can be realized and obtained by the apparatus particularly pointed out in the appended claims.

To overcome the problems of the prior art methods and in accordance with the purpose of the invention, as embodied and broadly described herein, a photocatalytic air purifier of the present invention briefly includes a tubular housing having an inner and an outer wall, a central axis, a first end having a centrally located air intake nozzle, a second end having at least one air exhaust port, an air exhaust plenum between the inner housing wall and a radial porosity medium, the porosity medium extending radially and axially about the axis, and a housing central portion defined by an interior perimeter of the radial porosity medium, the central housing enclosing an ultraviolet lamp and a packing medium, the packing medium extending radially and axially about the lamp and comprising a plurality of spiral wound filaments coated with a photo catalytic film.

### BRIEF DESCRIPTION OF THE DRAWINGS

The accompanying drawings, which are incorporated in and which constitute a part of the specification, illustrate at least one embodiment of the invention and, together with the description, explain the principles of the invention.

FIG. 1 is a left isometric view of the photocatalytic air purifier for the removal of volatile organic compounds (VOCs) and bio-aerosols from an air stream.

FIG. 2 is a simple sectional side view illustrating the general construction and the operational features of the photocatalytic air purifier.

FIG. 3 is an enlarged frontal view of one-half of a strand of the bottle brush catalytic support filament component of the packing medium. The enlarged view is made to show that the catalyst is deposited on the filament and wire components, and the components comprise the packing medium.

FIG. 4 is a frontal view of a full strand of the bottle brush catalytic support filament and wire components, shown in FIG. 3, which comprises the packing medium. This figure illustrates winding of the filaments in a spiral about the central wire. In this manner, the bottle brush elements comprising the packing medium are self-supporting.

FIG. 5 is a left hand isometric cross sectional view of a preferred embodiment of the photocatalytic air purifier showing the details of construction.

FIG. 6 is a graph of test results showing the oxidation of methanol as a function of time for a wash coat TiO₂ catalytic surface deposited on nylon brushes at an air flow rate of 4 liters/minute. Nearly complete destruction of the methanol was achieved at about 2 liters/minute (not shown).

### DETAILED DESCRIPTION OF THE DRAWINGS

Unless specifically defined otherwise, all technical or scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. Reference now will be made in detail to the presently preferred embodiments of the invention, examples of which are illustrated in the accompanying drawings.

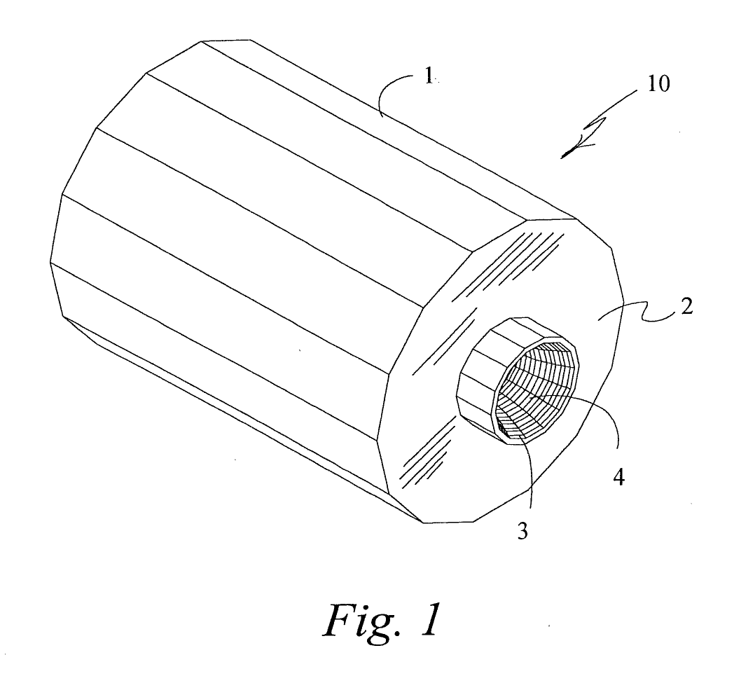

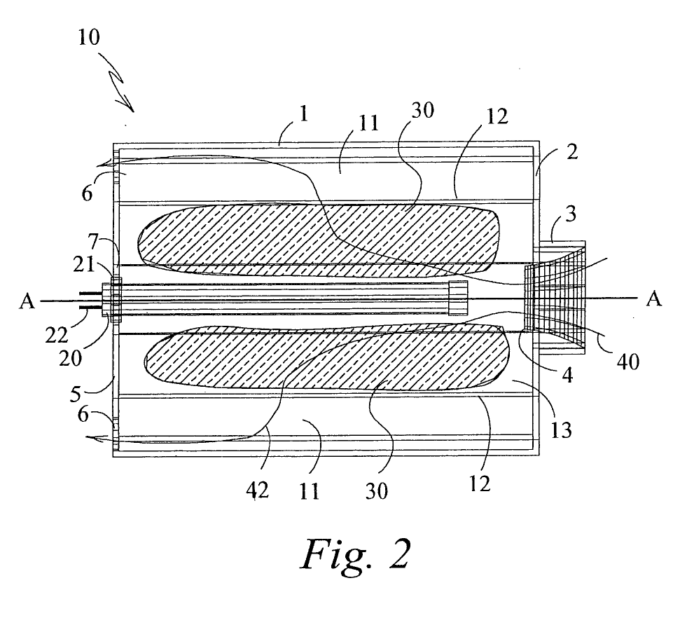

Referring now to the drawing figures, wherein like numerals represent like features, it is generally shown in FIG. 1 a left isometric view of the photocatalytic air purifier 10 for the removal of volatile organic compounds (VOCs) and bio-aerosols from an air stream. FIG. 2 shows a sectional side view illustrating the general construction and the operational features of the photocatalytic air purifier 10. Air purifier 10 includes a tubular housing 1 having an inner and an outer wall and a central axis A. At a first end 2 of the housing 1 is an enclosure 3 with a contaminated air intake nozzle 4 centrally located. The second end 5 of the housing 1 is an enclosure with at least one clean air exhaust port 6 and a central opening 7, which can be sealed, at the axis A for receiving a ultraviolet light source 20.

Referring inwardly from the inner wall of housing 1 to the central axis A, an air exhaust plenum 11 is defined between the housing 1 inner wall and a radial porosity medium 12. The porosity medium 12 extends radially and axially about the axis A thereby defining a housing inner central portion 13 for enclosing a packing medium 30 and ultraviolet lamp 20. The packing media 30 is located within the central portion 13 and extends radially and axially about the lamp 20. The lamp 20 is fixed at the central axis A of the housing 1 and is supported through an opening 7 in the second end 5 with lamp electrical connectors 22 protruding outside of the housing second end 5 to a power supply (not shown).

Air contaminated with VOCs or bio-aerosols 40 is introduced into the photocatalytic air purifier 10 at the first end of the housing 1 through the intake nozzle 4, either by means of a housing 1 pressure or vacuum condition. In this manner, contaminated air 40 initially flows axially within the central portion 13 and adjacent to the lamp 20. The plenum chamber 11 and clean air exhaust port(s) 6 configuration redirects the axial air flow 40 radially 42 through the packing medium 30 and porosity 12 medium and then within the plenum 11 to the port 6 where clean air is exhausted from the purifier 10.

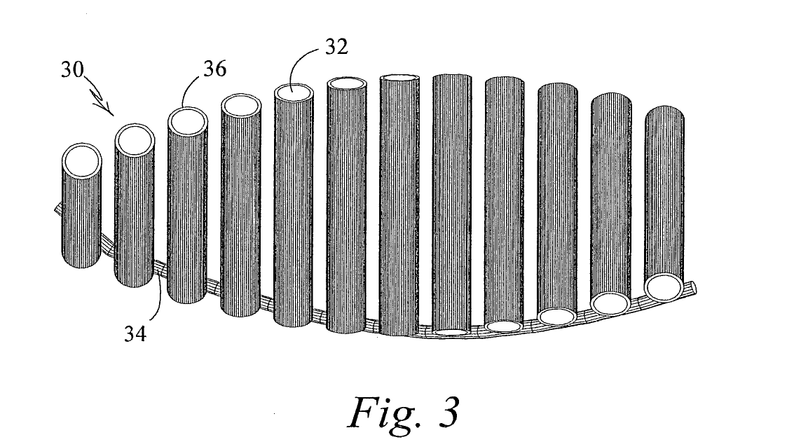

A detailed frontal view of a component of the packing medium 30 is now shown in FIG. 3. While the packing media 30 can be made of any binder-free material characterized by a large surface and low air flow resistance, the preferred packing media 30 includes a plurality of very small diameter bound filaments 32, in a “bottle brush” configuration, by securing them together in a spiral relationship to one another with a twisted strand 34. The filaments 32 serve as a support for a photocatalyst 36 which is deposited on the filaments 32. The filaments 32 can be fabricated from metal, plastic, nylon or any other material that can be assembled into small fibers. This configuration has the advantage of providing the a high surface area and low pressure drop, and when they are made of glass or plastic, the filaments are semi-transparent to ultraviolet light. The filaments 32 are preferably coated with the anatase form of titanium dioxide which servers as the photocatalyst 36.

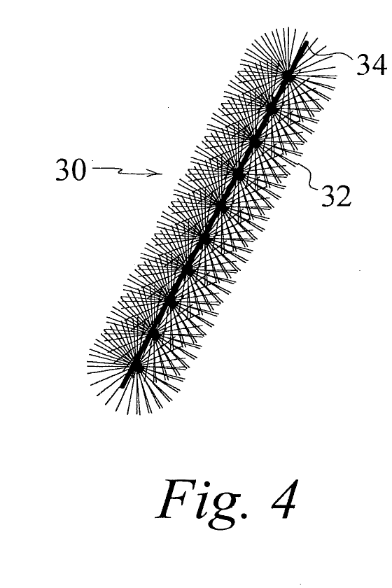

Referring now to FIG. 4, one can see a frontal view of a full strand of the bottle brush catalytic support filament and wire components which comprises the packing medium. This figure illustrates winding of the filaments in a spiral form about the central wire. Manufacturing methods for spiral binding the filaments 32 in the form of a bottle brush design are well known. The process is automated and starts with monofilament fibers of the desired material in a given fiber diameter and length. However, the use of glass filaments and, the use of E-glass having a filament diameter in the range of 15 to 20 microns is preferred. Smaller diameter filaments are more particularly preferred over larger diameter filaments, because the smaller the diameter of the filament, the greater the net surface area of the resulting packing media 30 resulting in a more efficient removal of contaminants from the intake air. The filaments 32 are affixed to a twisted support strand 34, which preferably includes a pair of metal wires (one shown) such that the filaments 32 extend perpendicular to the wire 34. The length of the filaments 32 can also be varied in order to modify the packing density of the packing media 30. The length of an assembled bottle brush catalytic support can also be varied from less than one inch to many feet, depending on the desired application of the purifier. One advantage of this design is that the geometry of the bottle brush is self-supporting when loaded into a given volume. Consequently no binders are needed to prevent the fibers components of the packing media from collapsing on themselves. It is also contemplated herein that the bottle brush packing media would be made in very long lengths, such that they could be molded into a specific geometry depending upon the desired application. For example, they could be made into self supporting flat panels or wound into spiral cylinders.

Referring once again to FIG. 3, as mentioned above, the individual filaments 32 and support 34 are then coated with a photocatalyst 36 such as titanium dioxide. The photocatalyst 36 can be applied using a simple wash coating which includes dipping the filaments in an appropriate photocatalyst mixture and then drying the mixture. This process can be repeated any number of times in order to increase the loading of photocatalyst 36 on the surface of the filaments 32 and support strand 34. When using glass filaments, one can also use any sol-gel process, well known in the art, such as applying a TiO₂ solution, followed by thermal treatment at temperatures in the range of 100 to 500° C., for coating the filament 32 surface with the titanium dioxide deposit. It is mostly preferred to use a combination of stainless steel wire as the support strand 34 and E-glass filaments 32 because this combination provides the greatest flexibility in formulating application of the catalytic medium, and it also increases the effective illumination of the catalytic surface through the partial transmission of light through the glass.

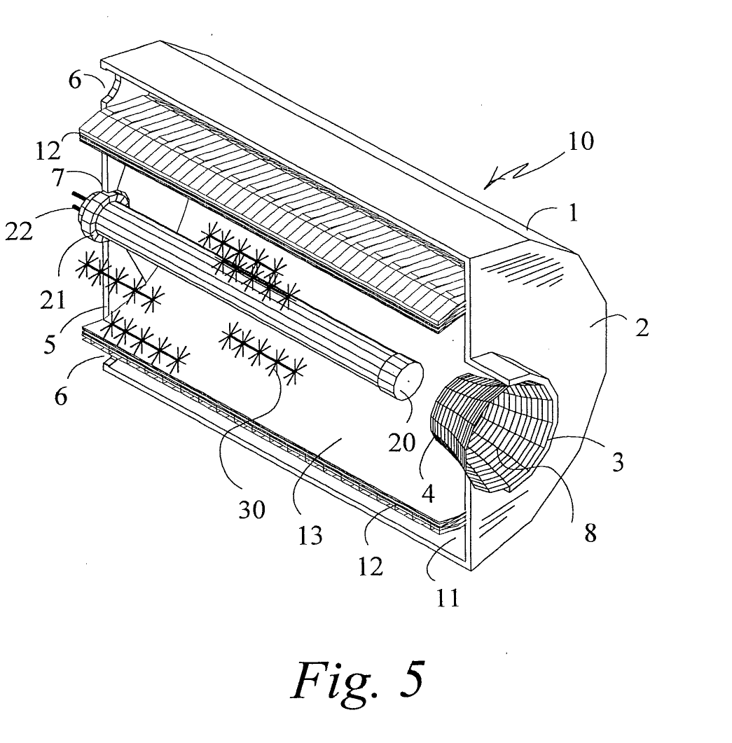

Referring now to FIG. 5 wherein it is shown a left hand isometric cross sectional view of a preferred embodiment of the present invention. As contaminated air passes through the housing 1 central portion 13 along the lamp 20 and through the packing medium 30, contaminants are adsorbed onto the catalytic surface of the packing medium 30. At this time, the packing medium 30 is light illuminated in the range of 285 to 460 nm. The lamp 20 preferably emanates light in the range 300 to 400 nm and more preferably at a wavelength of 365 nm. Wavelengths below 300 nm can be used where warranted either by the specific application of the air to be cleansed or as a result of the materials for construction. Upon light illumination of the catalyst coated packing medium 30, any VOCs or bio-aerosols are primarily oxidized to CO₂ and H₂O.

Novel technical features of the photocatalytic air purifier include the fact that the distribution of contaminated air through the packing media 30 is enhanced by selecting the appropriate dimensions for the air inlet 4 and exhaust 6 openings and fixing the appropriate porosity of the medium. For example, it is particularly desirable to design the porosity medium 12 such that it includes a gradient in pore size, the pores smaller in diameter at the exhaust openings 6 and gradually increasing in size as they approach the air inlet 4 end of the housing 1. These dimensions determine the localized stream flow velocities which, in turn, influence air distribution within the packing media 30.

Once fabricated and coated with the catalyst, short segments of the individual bottle brush components of the packing media brush-like catalyst are then simply dropped into the central housing 13 around the lamp 20 or can be shaped into a cylinder by winding a long rope of the filaments and support strand. Other shapes such a flat plates, curved panels, or rectangular channels can be formed by long “ropes” of the bottle brush support by spiral winding it on a cylindrical form or arranging it in serpentine form within a frame of the desired shape (not shown). In this manner, easy replacement of the packing media is permitted, and, when necessary, different catalyst formulations can be used as components of the packing media 30 when desired.

Referring again to FIG. 5 the housing 1 itself is multifunctional. It serves as the container for the packing medium 30 and secures the lamp 20 to a central axis A at the second housing end 5. It further acts to channel the flow of air through the packing medium 30. To obtain the maximum effectiveness of the air purifier 10, it is important to achieve as near uniform as possible of air flow distribution through the packing media 30. Thus, a unique aspect of the purifier 10, according to the present invention, is that the distribution of the air flow from housing air inlet 4 through packing medium 30 is influenced by the overall design of the housing 1. The optimal dimensions for the air inlet 4 and outlet 6 openings have been identified so that the flow distribution through an empty housing 1 gives a preferred flow path through the housing central portion 13 containing the packing media 30. While not illustrated in the drawing, the use of a variable porosity medium 12 as the barrier between the housing central portion 13, containing the packing medium 30, and the plenum chamber 11, where the purified air gathers for exhaust at housing end 5 exhaust port 6, forces the flow to change in direction and flow normal to the axis A and through what would otherwise be a stagnant zone. These design features result in a more effective flow path of contaminated air through the packing media 30. This is accomplished without the need for a flow distributor between the lamp 20 and packing media 30 that would otherwise direct the air flow throughout the packing media 30, but would prevent optimal transmission of light onto the catalyst surface.

Preferably, the housing 1 is made inexpensively by injection molding. The housing 1 is desirably comprised of three separate component pieces: a second end cap 5 with an appropriate socket or compression fitting 21 to secure the lamp 20 along the central axis A; a cylindrical chamber (between the ends 5 and 2) that includes the porosity medium 12 and the exit plenum 11, and; an end cap which includes the first end 2 with a venturi opening 8 leading to an appropriate size diameter air inlet nozzle 4. The curved venturi opening 8 is helpful to facilitate a smoothing of the air flow as it is channeled through the packing medium 30. The ratio of the diameter of the inlet air opening 4 to the inside wall diameter of the housing 1 is therefore desirably in the range of 0.40 to 0.45. The ratio of the volume of the plenum chamber 11 to the volume of the main cylindrical chamber of housing 1 is desirably in the range of 0.60 to 0.65. These dimensions help facilitate the desired distribution of air through the packing media void volume. Constructed in this manner, these three housing 1 component sections would be configured for a simple snap fit or thread connection, according to any well know method, and should further reduce the cost of manufacture and facilitate replacement of the bottle brush packing media 30.

### EXAMPLE

The following example illustrates the manner in which photocatalytic air purifier in accordance with the present invention can be used.

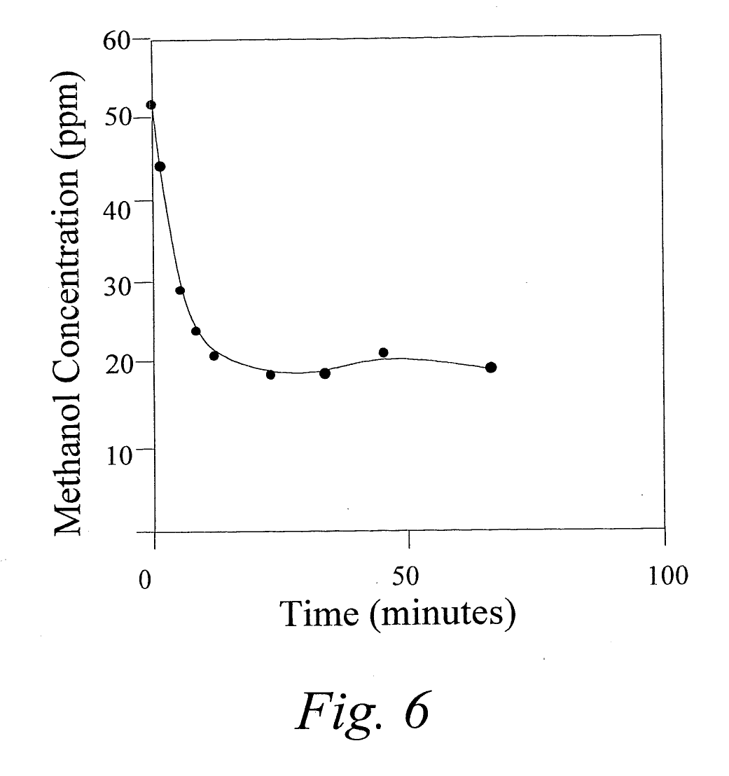

FIG. 6 shows a graph of test results on the oxidation of methanol as a function of time. An prototype purifier, as show above, was initially tested at an air flow rate of 2 liters/minute with 50 ppm methanol in the air. At this rate, the destruction of methanol was nearly complete. Therefore, subsequent tests were conducted at 4 liters/minute. At this rate, as shown in the drawing figure, the methanol levels were reduced by 60 to 70 percent. The pressure drop resulting from the flow of air was too low to be measured on a gauge normally used in the testing apparatus. Based on initial design criteria, the overall performance yielded unexpected results. The device was originally designed for application in removing VOCs and bioaerosols from an automobile cabin air, but it would find utility for the oxidation of chemical or biological agents.

While the present invention has been described in connection with the illustrated embodiments. It will be appreciated and understood that modifications may be made without departing, from the true spirit and scope of the invention.

1. A Photocatalytic air purifier, comprising:
(a) a tubular housing having an inner and an outer wall, a central axis, a first end having a centrally located air intake nozzle, a second end having at least one air exhaust port;
(b) an air exhaust plenum between the inner housing wall and a radial porosity medium, the porosity medium extending radially and axially about the axis; and
(c) a housing central portion defined by an interior perimeter of the radial porosity medium, the central housing enclosing an ultraviolet lamp and a packing medium, the packing medium extending radially and axially about the lamp and comprising a plurality of spiral wound filaments coated with a photo catalytic film.

2. The air purifier of claim 1 wherein the filaments are semi-transparent to ultraviolet light.

3. The air purifier of claim 1 wherein the photo catalytic film is titanium dioxide.

4. The air purifier of claim 1 wherein the lamp is located at the central axis of the housing and supported through an opening in the second end.

5. The air purifier of claim 1 wherein the ultraviolet light is a wavelength of approximately 365 nm.

6. The air purifier of claim 1 wherein the air intake nozzle further comprises a venturi converging section.

7. The air purifier of claim 1 wherein the spiral wound filaments are centrally bound with at least one stainless steel wire.

8. The air purifier of claim 1 wherein a ratio of the diameter of the air inlet opening to the diameter of the inner wall is in the range of 0.40 to 0.45.

9. The air purifier of claim 1 wherein a ratio of the volume of the plenum to the volume of the housing is in the range of 0.60 to 0.65.

10. The air purifier of claim 1 wherein the porosity medium comprises a variable pore size gradient.

11. The air purifier of claim 2 wherein the filaments are E-glass.

12. The air purifier of claim 2 wherein the filaments are in a range of 15 to 20 microns in diameter.

13. The air purifier of claim 2 wherein coating the catalyst is applied using a sol-gel process.
